(19) United States
(12) Patent Application Publication
(10) Pub. No.: US 2015/0163071 A1
(43) Pub. Date: Jun. 11, 2015

(54) WIRELESS TRANSMISSION DEVICE, WIRELESS TRANSMISSION SYSTEM, COMMUNICATION LINE SELECTION METHOD

(71) Applicant: NEC Corporation, Tokyo (JP)

(72) Inventor: Makoto Otsu, Tokyo (JP)

(21) Appl. No.: 14/411,677

(22) PCT Filed: Jun. 25, 2013
(86) PCT No.: PCT/JP2013/003962

§ 371 Date: Dec. 29, 2014

(30) Foreign Application Priority Data
Jul. 2, 2012 (JP) 2012-148403

(51) Int. Cl. H04L 12/437; H04L 12/24; H04W 76/02; H04W 24/04

(52) U.S. Cl. CPC H04L 12/437; H04W 24/04; H04L 41/0672; H04W 76/027

(57) ABSTRACT

In order to continue transmission of extra traffic in the absence of an unused transmission path, a transmission system of the present invention is a wireless transmission system comprising two or more wireless transmission devices are connected via a plurality of wireless transmission paths. The wireless transmission device is a wireless transmission device for transmitting traffic to another wireless transmission device via a wireless transmission path selected from a plurality of connected wireless transmission paths. The wireless transmission system comprises a switching control unit which judges, when a fault has occurred in the wireless transmission path for transmitting the traffic, whether the traffic is transmittable with use of the wireless transmission path in which the fault has occurred, namely, a faulty transmission path, and which selects the faulty transmission path, as the wireless transmission path for transmitting the traffic, when judging that the traffic is transmittable.

### TECHNICAL FIELD

The present invention relates to a wireless transmission device, a wireless transmission system, and a communication line selection method, and more particularly, to a wireless transmission device, a wireless transmission system, and a communication line selection method for continuing transmission of low priority information, without affecting transmission of high priority information.

### BACKGROUND ART

In recent years, as the Internet has developed and globalization has progressed, both domestic and international large-capacity trunk transmission networks have progressed. A general trunk transmission network is used for transmitting information of a variety of users. Therefore, the trunk transmission network is required to be a transmission network which is less likely to cause line disconnection. In view of the above, the general trunk transmission network is constituted of a duplex transmission path having an active system and a standby system. When a line fault has occurred in the active system transmission path, a transmission device on the trunk transmission network switches the transmission path to the standby system transmission path for saving a transmission signal. Further, in the general trunk transmission network, a technique of connecting a duplex transmission path in the form of a ring, and bypassing a transmission signal to a transmission path in the opposite direction, even when a line fault has occurred in a partial section, in other words, in both of the active system and standby system transmission paths has come into practical use in order to enhance the reliability of the transmission network.

Incidentally, in the transmission system in which the duplex transmission path is connected in the form of a ring (hereinafter, called as a “ring-type transmission system”) as described above, the standby system transmission path is in an idling state when there is no line fault in the active system transmission path. Generally, a standby system transmission path has the same transmission capacity as an active system transmission path. Therefore, taking into consideration the overall system, only half of the maximum transmittable capacity is used. Thus, the transmission efficiency is poor. In view of the above, Patent Literature 1 and Patent Literature 2 disclose a technique of transmitting low priority transmission information (hereinafter, called as “extra traffic”) via a standby system transmission path in order to enhance the transmission efficiency of the ring-type transmission system.

However, in the technique disclosed in Patent Literature 1 and the like, high priority information (hereinafter, called as “service traffic”) that has been transmitted via an active system transmission path is bypassed to a standby system transmission path, when a line fault has occurred in the active system transmission path. This results in disconnection of extra traffic. In view of the above, Patent Literature 3 discloses a technique of bypassing extra traffic to an unused standby system transmission path or active system transmission path so that the extra traffic is not cut off, even when a line fault has occurred in the transmission path along which the service traffic has been transmitted. The above-described “unused standby system transmission path or active system transmission path” is hereinafter simply called as an “unused transmission path”.

### CITATION LIST

### Patent Literature

[PTL 1] Japanese Patent Application Publication No. 2000-78176

[PTL 2] Japanese Patent Application Publication No. 2000-83042

[PTL 3] Japanese Patent Application Publication No. 2003-143171

### SUMMARY OF INVENTION

### Technical Problem

However, the ring-type transmission system disclosed in Patent Literature 3 has a problem such that when an unused transmission path is not available in bypassing the extra traffic at the time of line fault, transmission of the extra traffic cannot be continued.

The reason for the above is that the ring-type transmission system disclosed in Patent Literature 3 (hereinafter, called as the “transmission system of Patent Literature 3”) constitutes transmission paths with a wired line configured such that the line is completely disconnected at the time of line fault. As a result, in the transmission system of Patent Literature 3, when an unused transmission path is not available, there is no transmission path for bypassing the extra traffic, and it is not possible to continue transmission of the extra traffic.

An object of the present invention is to provide a wireless transmission device, a wireless transmission system, and a communication line selection method which solves the above-described problem.

### Solution to Problem

To achieve the above-described object, a wireless transmission device of the present invention is a wireless transmission device for transmitting traffic to another wireless transmission device via a selected one of a plurality of connected wireless transmission paths. The wireless transmission device comprises a switching control unit which judges, when a fault has occurred in the wireless transmission path for transmitting the traffic, whether the traffic is transmittable with use of the wireless transmission path in which the fault has occurred, namely, a faulty transmission path, and which selects the faulty transmission path, as the wireless transmission path for transmitting the traffic, when judging that the traffic is transmittable.

To achieve the above-described object, a wireless transmission system of the present invention is a wireless transmission system comprising two or more wireless transmission devices connected via a plurality of wireless transmission paths. The wireless transmission device is a wireless transmission device for transmitting traffic to another wireless transmission device via a wireless transmission path selected from a plurality of connected wireless transmission paths. The wireless transmission device comprises a switching control unit which judges, when a fault has occurred in the wireless transmission path for transmitting the traffic, whether the traffic is transmittable with use of the wireless transmission path in which the fault has occurred, namely, a faulty transmission path, and which selects the faulty transmission path, as the wireless transmission path for transmitting the traffic, when judging that the traffic is transmittable.

To achieve the above-described object, a communication line selection method of the present invention is a communication line selection method for selecting a wireless transmission path from a plurality of wireless transmission paths so as to transmit traffic to a communication destination. the communication line selection method comprises, when a fault has occurred in the wireless transmission path for transmitting the traffic, judging whether the traffic is transmittable with use of the wireless transmission path in which the fault has occurred, namely, a faulty transmission path, and selecting the faulty transmission path as the wireless transmission path for transmitting the traffic, when judging that the traffic is transmittable.

### Advantageous Effects of Invention

According to the present invention, the transmission system is capable of continuing transmission of extra traffic without affecting transmission of service traffic, even when an unused transmission path is not available at the time of line fault.

### BRIEF DESCRIPTION OF DRAWINGS

FIG. 1 is a diagram illustrating a configuration example of a wireless transmission system in a first exemplary embodiment of the present invention.

FIG. 2A is a diagram illustrating a configuration example of a wireless transmission device constituting the wireless transmission system in the first exemplary embodiment of the present invention.

FIG. 2B is a diagram illustrating a configuration example of the wireless transmission device constituting the wireless transmission system in the first exemplary embodiment of the present invention.

FIG. 2C is a diagram illustrating a configuration example of the wireless transmission device constituting the wireless transmission system in the first exemplary embodiment of the present invention.

FIG. 3A is a diagram for representing adaptive modulation to be performed by the wireless transmission device in the first exemplary embodiment of the present invention.

FIG. 3B is a diagram for representing adaptive modulation to be performed by the wireless transmission device in the first exemplary embodiment of the present invention.

FIG. 4 is a diagram illustrating an example of a communication path set in the wireless transmission system in the first exemplary embodiment of the present invention.

FIG. 5 is a diagram illustrating a setting example of a communication path, when a fault has occurred in an active system transmission path of the wireless transmission system in the first exemplary embodiment of the present invention.

FIG. 6 is a diagram illustrating a setting example of a communication path, when a fault has occurred in active system and standby system transmission paths of the wireless transmission system in the first exemplary embodiment of the present invention.

FIG. 7 is a flowchart illustrating a traffic bypass operation to be performed by the wireless transmission device in the first exemplary embodiment of the present invention.

FIG. 8 is a diagram illustrating a setting example of a communication path, when a fault has occurred in the standby system transmission path of the wireless transmission system in the first exemplary embodiment of the present invention.

FIG. 9 is a diagram illustrating a setting example of a communication path, when a path for bypassing extra traffic is not available in the wireless transmission system in the first exemplary embodiment of the present invention.

FIG. 10 is a diagram illustrating a configuration example of a wireless transmission system in a second exemplary embodiment of the present invention.

### DESCRIPTION OF EMBODIMENTS

In the following, exemplary embodiments of the present invention are described in detail referring to the drawings.

### First Exemplary Embodiment

### Description of Configuration

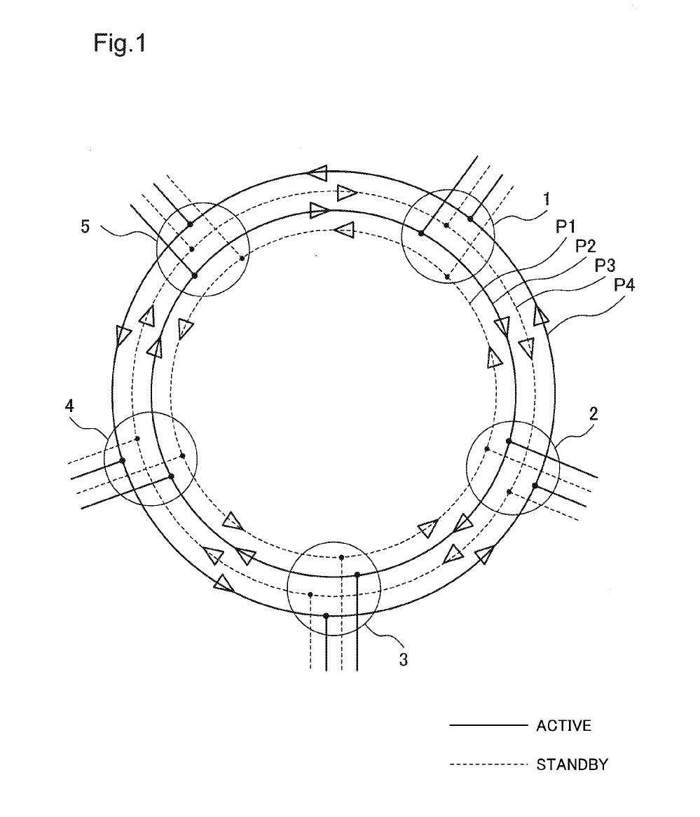

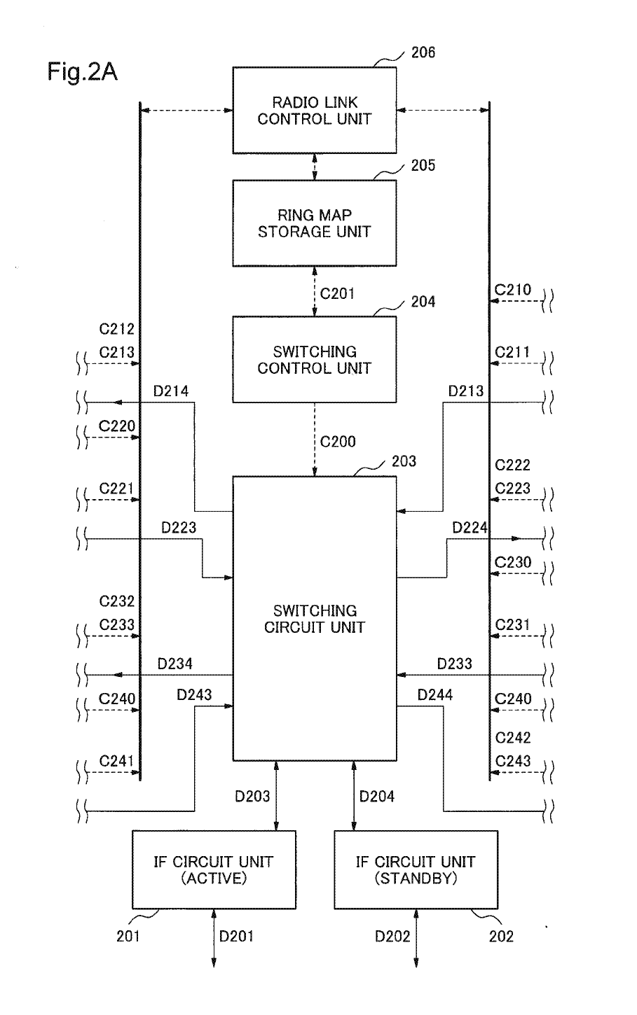

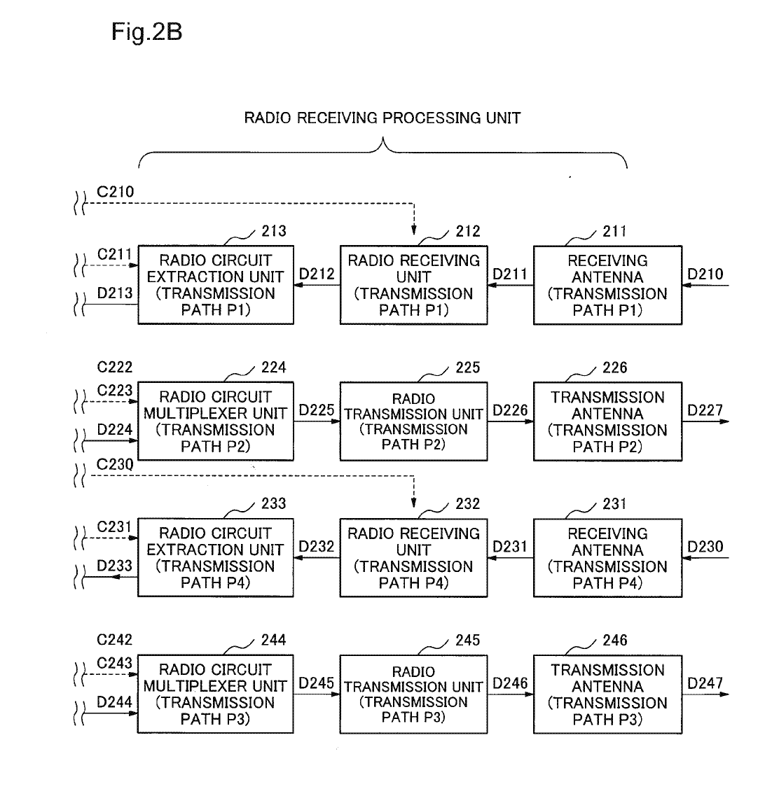

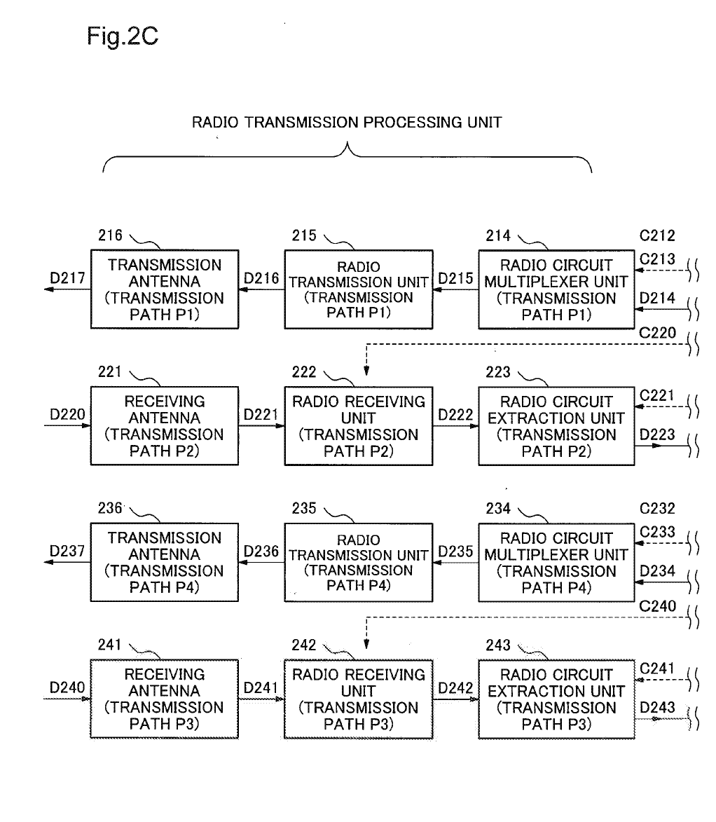

FIG. 1 is a diagram illustrating a configuration example of a wireless transmission system in a first exemplary embodiment of the present invention. Further, FIG. 2A, FIG. 2B, and FIG. 2C are diagrams illustrating a configuration example of a wireless transmission device constituting the wireless transmission system in the first exemplary embodiment of the present invention.

(1) Configuration of Wireless Transmission System

As illustrated in FIG. 1, the wireless transmission system in the first exemplary embodiment is constituted of a plurality of wireless transmission devices 1 to 5. Further, the wireless transmission devices 1 to 5 are connected in the form of a ring by active system wireless transmission paths P2 and P4, and standby system wireless transmission paths P1 and P3 having a clockwise or counterclockwise line. Although not illustrated, each of the wireless transmission devices 1 to 5 is connected to a supervisory control device via a wired line such as an LAN (Local Area Network).

While five wireless transmission devices are illustrated in FIG. 1, the number of wireless transmission devices is not limited to five. The number of wireless transmission devices may be four or less, or may be six or more. Further, while four wireless transmission paths are illustrated in FIG. 1, the number of wireless transmission paths is not limited to four. The number of wireless transmission paths may be three or less, or may be five or more.

(2) Basic Operation of Wireless Transmission System

The wireless transmission system in the first exemplary embodiment sets a communication path for use in transmitting information (hereinafter, called as a “communication path”) by a well-known function, as well as the transmission system disclosed in Patent Literature 3. For instance, when information is transmitted from the wireless transmission device 1 to the wireless transmission device 3 in FIG. 1, the wireless transmission system in the present exemplary embodiment sets a communication path on the wireless transmission path P2 between the wireless transmission devices 1 to 3, and performs information transmission on the communication path.

(3) Configuration and Function of Wireless Transmission Devices 1 to 5

(3-1) Configuration of Wireless Transmission Devices 1 to 5

As illustrated in FIG. 2A, the wireless transmission devices 1 to 5 are constituted of IF circuit units 201 and 202, a switching circuit unit 203, a switching control unit 204, a ring map storage unit 205, and a radio link control unit 206. Further, as illustrated in FIG. 2B and FIG. 2C, the wireless transmission devices 1 to 5 are constituted of receiving antennas 211, 221, 231, and 241, radio receiving units 212, 222, 232, and 242, and radio circuit extraction units 213, 223, 233, and 243. Further, as illustrated in FIG. 2B and FIG. 2C, the wireless transmission devices 1 to 5 are constituted of radio circuit multiplexer units 214, 224, 234, and 244, radio transmission units 215, 225, 235, and 245, and transmission antennas 216, 226, 236, and 246.

(3-2) Connection of Components of Wireless Transmission Devices 1 to 5

First of all, the receiving antennas 211, 221, 231, and 241 are connected to the wireless transmission paths P1 to P4. Specifically, the receiving antenna 211 is connected to the active system wireless transmission path P1, and the receiving antenna 221 is connected to the standby system wireless transmission path P2. Further, the receiving antenna 231 is connected to the active system wireless transmission path P4, and the receiving antenna 241 is connected to the standby system wireless transmission path P3. Furthermore, the receiving antennas 211, 221, 231, and 241 are respectively connected to the radio receiving units 212, 222, 232, and 242, and the radio receiving units 212, 222, 232, and 242 are respectively connected to the radio circuit extraction units 213, 223, 233, and 243. The radio circuit extraction units 213, 223, 233, and 243 are connected to the switching circuit unit 203.

The switching circuit unit 203 is connected to the radio circuit multiplexer units 214, 224, 234, and 244. The radio circuit multiplexer units 214, 224, 234, and 244 are respectively connected to the radio transmission units 215, 225, 235, and 245. Further, the radio transmission units 215, 225, 235, and 245 are respectively connected to the transmission antennas 216, 226, 236, and 246, and the transmission antennas 216, 226, 236, and 246 are connected to the wireless transmission paths P1 to P4. Specifically, the transmission antenna 216 is connected to the active system wireless transmission path P1, and the transmission antenna 226 is connected to the standby system wireless transmission path P2. Further, the transmission antenna 236 is connected to the active system wireless transmission path P4, and the transmission antenna 246 is connected to the standby system wireless transmission path P3.

Although not illustrated, the IF circuit units 201 and 202 are connected to a user terminal, for instance, to a PC (Personal Computer) via a wired line such as an LAN. Further, the IF circuit units 201 and 202 are connected to the switching circuit unit 203, and the switching circuit unit 203 is connected to the switching control unit 204. Furthermore, the switching control unit 204 is connected to the ring map storage unit 205. In addition, the radio link control unit 206 is connected to the ring map storage unit 205, the radio receiving units 212, 222, 232, and 242, the radio circuit extraction units 213, 223, 233, and 243, and the radio circuit multiplexer units 214, 224, 234, and 244. Although not illustrated, the switching control unit 204 and the ring map storage unit 205 are connected to the supervisory control device via a wired line such as an LAN.

(3-3) Function of Components of Wireless Transmission Devices 1 to 5

The IF circuit unit 201 and the IF circuit unit 202 convert input service traffic or extra traffic into data in the data format of a wired line, and output the converted data as transmittable data by the wired line. Further, the IF circuit unit 201 and the IF circuit unit 202 convert data input from a wired line into service traffic or extra traffic in accordance with the data format, and output the service traffic or extra traffic.

The switching circuit unit 203 outputs the input service traffic or extra traffic to an output destination transmission path represented by switching control information. The above-described switching control information is control information representing an input source transmission path and an output destination transmission path, and is input to the switching circuit unit 203. For instance, when switching control information representing that the input source transmission path=P1 and the output destination transmission path=P4 is input, the switching circuit unit 203 outputs, to the wireless transmission path P4, service traffic or extra traffic received from the wireless transmission path P1. When switching control information representing that the input source transmission path=P1 and the output destination transmission path=IF circuit unit 201 is input, the switching circuit unit 203 outputs, to the IF circuit unit 201, service traffic or extra traffic input from the wireless transmission path P1.

The switching control unit 204 monitors the presence or absence of a fault in each of the wireless transmission paths. Specifically, the switching control unit 204 measures a traffic amount of service traffic or extra traffic to be received by the switching control unit 204 (hereinafter, called as a “received traffic amount”) for each of the wireless transmission paths. Further, when a transmission traffic amount of each of the wireless transmission paths (the details thereof are described later in the section “(4) Supervisory Control Device”) is input to the switching control unit 204, the switching control unit 204 checks whether there is a wireless transmission path whose ratio of the received traffic amount with respect to the transmission traffic amount is not larger than a predetermined value for a predetermined period. As a result of the checking, when there is such a wireless transmission path as described above, the switching control unit 204 detects that the wireless transmission path is a wireless transmission path having a line fault. The predetermined period and the predetermined value are set in the switching control unit 204 by the user of the wireless transmission system in the present exemplary embodiment. The predetermined value may be variable in accordance with the transmission traffic amount.

When a wireless transmission path having a line fault is detected, the switching control unit 204 outputs information representing the wireless transmission path in which the line fault has occurred (hereinafter, called as a “faulty line”), and a fault status of the faulty line. The fault status includes an SNR (Signal to noise ratio) value of an input faulty line.

Further, when a fault information notification is input, the switching control unit 204 judges whether it is necessary to bypass the service traffic or extra traffic being transmitted, based on the fault information notification or an input ring map. A concrete method for judging whether it is necessary to bypass the traffic is described later in detail in the section “(6-2) Operation of switching circuit unit 203/switching control unit 204”. Further, the above-described fault information notification is a notification representing that a fault has occurred somewhere in a wireless transmission path on the wireless transmission system. The details of the fault information notification are described later in the section “(4) Supervisory control device”. The above-described ring map is information representing how a communication path is set on a wireless transmission path of the wireless transmission system in the present exemplary embodiment.

When the switching control unit 204 judges that it is necessary to bypass the service traffic or extra traffic, the switching control unit 204 selects a wireless transmission path for bypassing the service traffic or extra traffic. The method for selecting a wireless transmission path for bypassing the service traffic or extra traffic (hereinafter, called as a “bypass transmission path”) is described later in detail in the section “(6-2) Operation of switching circuit unit 203/switching control unit 204”). The switching control unit 204 that has selected a bypass transmission path outputs switching control information (representing that the output destination transmission path=selected bypass transmission path, and the input source transmission path=present transmission path). When a wireless transmission path for bypassing the extra traffic is not available, the switching control unit 204 checks whether it is possible to bypass the extra traffic with use of a faulty line even at a lower speed, based on the input SNR value or modulation method of a faulty line. Specifically, when the input modulation method of the faulty line is a modulation method whose multi-value number is not larger than a predetermined value, and the input SNR value of the faulty line is not lower than a predetermined value, the switching control unit 204 judges that it is possible to transmit the extra traffic by the faulty line at a low speed, and it is possible to bypass the extra traffic. The user of the wireless transmission system in the present exemplary embodiment is allowed to set the above-described predetermined value and the predetermined multi-value number in the switching control unit 204. When it is possible to transmit the extra traffic by the faulty line, the switching control unit 204 selects the wireless transmission path in which a fault has occurred, as a wireless transmission path for bypassing the extra traffic. The switching control unit 204 outputs switching control information representing that the output destination transmission path=faulty line, and the input source transmission path=present transmission path.

Next, the functions of the ring map storage unit 205 and the radio link control unit 206 are described.

The ring map storage unit 205 stores an input ring map. The ring map is input from the supervisory control device. Further, the ring map storage unit 205 stores an input modulation method and SNR value for each of the wireless transmission paths.

The radio link control unit 206 selects a modulation method of each of the wireless transmission paths in accordance with an input SNR value of each of the wireless transmission paths by a well-known technique, in other words, by adaptive modulation. The radio link control unit 206 outputs data representing a selected modulation method. Further, the radio link control unit 206 also outputs data representing an input modulation method. Furthermore, the radio link control unit 206 outputs the input SNR value of each of the wireless transmission paths.

The receiving antennas 211, 221, 231, and 241 receive radio signals to be input from the respective wireless transmission paths P1 to P4, amplify the radio signals, and output the amplified signals.

The radio receiving units 212, 222, 232, and 242 convert the input radio signals into IF (Intermediate Frequency) signals, demodulate the IF signals, and output the demodulated signals. Further, the radio receiving units 212, 222, 232, and 242 measure input SNR values of the radio signals, and output the measured values.

The radio circuit extraction units 213, 223, 233, and 243 extract the service traffic or extra traffic from the input demodulated radio signals in accordance with the format of a radio frame, and output the extracted service traffic or extra traffic. Further, the radio circuit extraction units 213, 223, 233, and 243 extract the overhead portion of the radio frame from the input demodulated radio signals in accordance with the format of the radio frame, and output the extracted overhead portion of the radio frame.

The radio circuit multiplexer units 214, 224, 234, and 244 multiplex the data representing the input modulation method, and the service traffic or extra traffic in the radio frame, and output the multiplexed data.

The radio transmission units 215, 216, 217, and 218 modulate the input signals, and output the modulated signals as radio signals. The radio transmission units 215, 216, 217, and 218 output radio signals in frequency bands different from each other so as to avoid interference. Further, the radio transmission units 215, 216, 217, and 218 extract data, which is multiplexed in the input data and represents the modulation method, and store the extracted data.

The transmission antennas 216, 226, 236, and 246 amplify the input radio signals, and output the amplified signals to the respective wireless transmission paths P1 to P4.

The components other than the ring map storage unit 205 are implemented with use of an electronic circuit, a DSP (Digital Signal Processor) or the like. The ring map storage unit 205 is implemented with use of a storage device such as an RAM (Random Access Memory).

The receiving antennas 211, 221, 231, and 241, the radio receiving units 212, 222, 232, and 242, and the radio circuit extraction units 213, 223, 233, and 243 are hereinafter generically called as “radio receiving processing units”. Further, the radio circuit multiplexer units 214, 224, 234, and 244, the radio transmission units 215, 216, 217, and 218, and the transmission antennas 216, 226, 236, and 246 are hereinafter called as “radio transmission processing units”. Furthermore, the radio receiving processing units, the radio transmission processing units, and the radio link control units 206 are generically called as a “radio transmitting and receiving unit”.

(4) Supervisory Control Device

In this section, the function of the unillustrated supervisory control device is described.

The supervisory control device collects a communication path presently set in the wireless transmission system by a well-known function, and outputs the collected communication path to the ring map storage unit 205 of each of the wireless transmission devices, as a ring map. The ring map is information representing how a communication path is set on a wireless transmission path of the wireless transmission system.

Further, the supervisory control device measures a traffic amount of service traffic or extra traffic to be input from the wired line side to the wireless transmission system (hereinafter, called as a “transmission traffic amount”) with use of a well-known technique. The supervisory control device recognizes, from the ring map, a wireless transmission path and a wireless transmission device in which a communication path (a transmission path for use in transmitting input service traffic or extra traffic) is set, and outputs the transmission traffic amount to the switching control unit 204 of the recognized wireless transmission device. When the transmission traffic amount is output to the recognized wireless transmission device, the supervisory control device outputs the transmission traffic amount in association with the wireless transmission path. Specifically, the supervisory control device outputs the recognized transmission traffic amount regarding a wireless transmission path in which a communication path is set, and outputs the transmission traffic amount of zero regarding a wireless transmission path in which a communication path is not set, out of the wireless transmission paths connected to the recognized wireless transmission device.

Further, the supervisory control device receives, from the switching control units 204 of the wireless transmission devices 1 to 5, information representing a faulty line, and a fault status. When information representing a faulty line, and a fault status are received, the supervisory control device obtains a faulty section by connecting the received faulty lines, and outputs the faulty section and the fault status to the switching control units 204 of the wireless transmission devices 1 to 5 as a fault information notification. Further, the supervisory control device outputs an input SNR value to the switching control unit 204. The supervisory control device has a function of outputting, to the switching control unit 204, a set value set by the user of the wireless transmission system in the present exemplary embodiment.

### Description on Operation of Wireless Transmission Device

The wireless transmission device in the present exemplary embodiment transmits and receives service traffic and extra traffic to and from another wireless transmission device via a wireless transmission path. Further, when a line fault has occurred, the wireless transmission device in the present exemplary embodiment bypasses the service traffic or extra traffic so as to continue transmission of the service traffic or extra traffic.

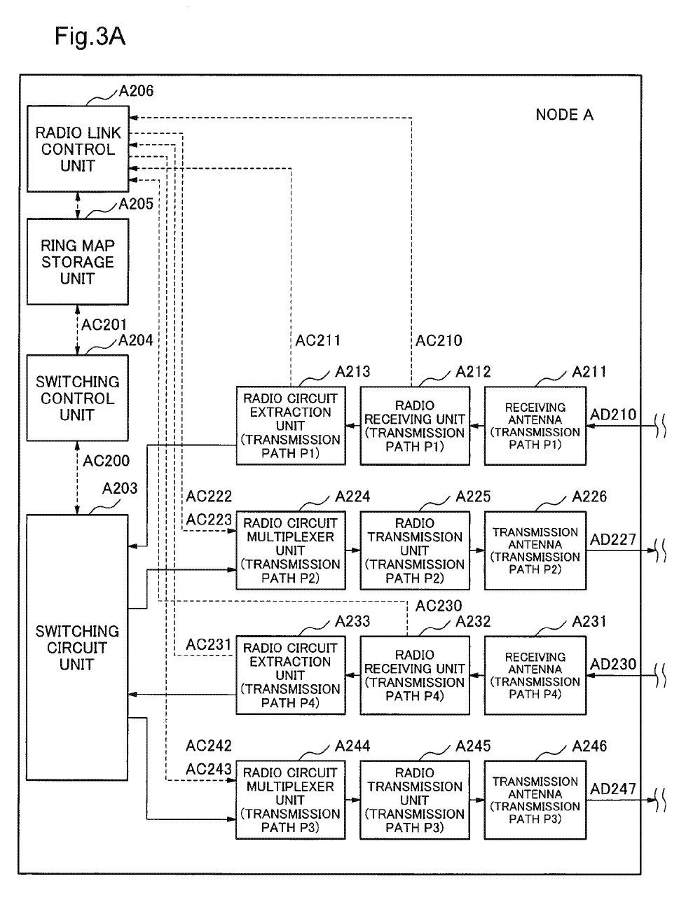

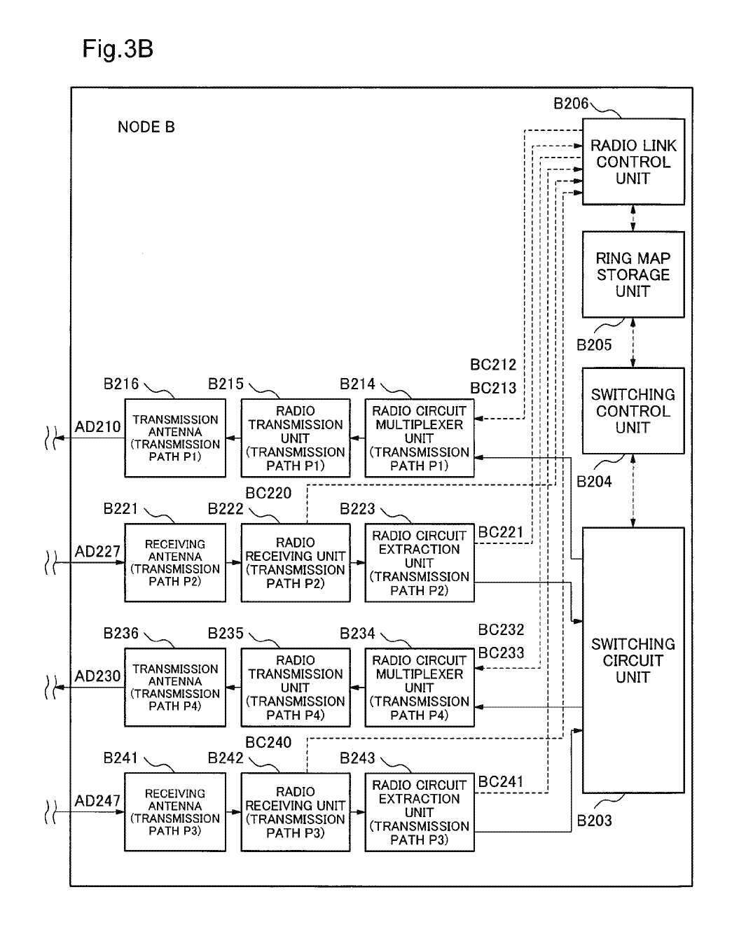

First of all, an operation of transmitting and receiving service traffic and extra traffic is described referring to FIG. 2A, FIG. 2B, FIG. 2C, FIG. 3A, and FIG. 3B. FIG. 3A and FIG. 3B are diagrams for representing adaptive modulation to be performed by a wireless transmission device in the first exemplary embodiment of the present invention.

(5) Operations of Transmitting and Receiving Service Traffic and Extra Traffic

Out of the transmitting operation and the receiving operation, the receiving operation is performed by each of the radio receiving processing units, and the transmitting operation is performed by each of the radio transmission processing units. Further, the modulation method for use in the transmitting operation (modulation process) of the wireless transmission processing unit, and in the receiving operation (demodulation process) of the radio receiving processing unit is calculated by the radio link control unit 206. In the following, the receiving operation, the transmitting operation, and the calculating operation of the modulation method are described. Since the receiving operation, the transmitting operation, and the calculating operation of the modulation method, which are performed for each of the wireless transmission paths, are the same among all the wireless transmission paths, those of the wireless transmission path P1 are described as a representative of the wireless transmission paths.

(5-1) Receiving Operation

First of all, the receiving operation is described referring to FIG. 2A and FIG. 2B.

First, the receiving antenna 211 receives a radio signal D210 on the wireless transmission path P1 output from the opposing wireless transmission device, amplifies the radio signal D210, and thereafter, outputs the amplified signal to the radio receiving unit 212 as a radio signal D211.

Subsequently, the radio receiving unit 212 converts the radio signal D211 into an IF signal, demodulates the IF signal, and thereafter, outputs the demodulated signal to the radio circuit extraction unit 213 as radio frame data D212. Further, the radio receiving unit 212 measures an SNR value of the radio signal D211, and outputs the measured value to the radio link control unit 206 as SNR information C210. The radio link control unit 206 outputs the SNR value input from the radio receiving unit 212 to the ring map storage unit 205. The ring map storage unit 205 stores the SNR value for each of the wireless transmission paths.

Subsequently, the radio circuit extraction unit 213 extracts service traffic or extra traffic D213 from the radio frame data D212 in accordance with the format of the radio frame, and outputs the extracted traffic D213 to the switching circuit 203. Further, the radio circuit extraction unit 213 separates overhead C211 of the radio frame from the radio frame data D212, and outputs the separated overhead data C211 to the radio link control unit 206. Data representing a modulation method used by the opposing wireless transmission device at the time of modulation (hereinafter, called as “modulation method information”), and data representing a modulation method used by the present wireless transmission device at the time of modulation (hereinafter, called as an “adaptive modulation request”) are multiplexed in the overhead by the opposing wireless transmission device.

The radio link control unit 206 extracts and acquires the modulation method information and the adaptive modulation request that have been multiplexed in the overhead data C211. Further, the radio link control unit 206 stores the acquired modulation method information.

(5-2) Transmitting Operation

In this section, the transmitting operation is described referring to FIG. 2A and FIG. 2C.

First of all, the radio circuit multiplexer unit 214 multiplexes service traffic or extra traffic D214 to be input from the switching circuit unit 203, and an adaptive modulation request C212 and modulation method information C213 to be input from the radio link control unit 206 in a radio frame. When the multiplexing operation is performed, the radio circuit multiplexer unit 214 multiplexes the service traffic or extra traffic D214 in a data portion of the radio frame, and multiplexes the adaptive modulation request C212 and the modulation method information C213 in the overhead portion of the radio frame. The radio circuit multiplexer unit 214 outputs the multiplexed data to the radio transmission unit 215 as radio frame data D215.

Subsequently, the radio transmission unit 215 extracts and stores the modulation method information C213 that has been multiplexed in the radio frame data D215. The radio transmission unit 215 modulates the radio frame data D215 with use of the modulation method information C213 (modulation method) stored at a time earlier by a predetermined time, and outputs the modulated data to the transmission antenna 216 as a radio signal D216. The predetermined time may be set in the radio transmission unit 215 by the user of the wireless transmission system in the present exemplary embodiment, or may be a time equal to a multiple of the radio frame length.

The transmission antenna 216 amplifies the radio signal D216, and outputs the amplified signal to the wireless transmission path P1.

(5-3) Calculating Operation of Modulation Method

The radio link control unit 206 in the present exemplary embodiment performs a well-known adaptive modulation for each of the wireless transmission paths. The radio link control unit 206 outputs, to the ring map storage unit 205, an adaptive modulation request, which is a result of performing a well-known adaptive modulation. In the following, an operation to be performed until the radio link control unit 206 outputs an adaptive modulation request to the ring map storage unit 205 is described referring to FIG. 3A and FIG. 3B. The node A in FIG. 3A and the node B in FIG. 3B are respectively a wireless transmission device in the present exemplary embodiment. Further, while the receiving antenna 211 of the node A is illustrated as a receiving antenna A211, and the receiving antenna 211 of the node B is illustrated as a receiving antenna B211 to simplify the description, in FIG. 3A and FIG. 3B, the operation and the configuration do not differ between the receiving antennas A211 and B211. The above idea is also applied to the other components.

First of all, the receiving antenna A211 of the node A receives a radio signal AD210 from the opposing node B, and outputs the received radio signal AD210 to a radio receiving unit A212. Subsequently, the radio receiving unit A212 estimates the SNR value of the radio signal AD210, and outputs SNR information AC210 to a radio link control unit A206. The radio link control unit A206 of the node A selects a modulation method whose multi-value number is small, as the modulation method (adaptive modulation request) of the wireless transmission path P1, when the value of the SNR information AC210 is smaller than a predetermined threshold value; and selects a modulation method whose multi-value number is large, as the modulation method (adaptive modulation request) of the wireless transmission path P1, when the value of the SNR information AC210 is larger than the predetermined threshold value. The predetermined threshold value is set in the radio link control unit A206 by the user of the wireless transmission system in the present exemplary embodiment. Subsequently, the radio link control unit A206 of the node A defines the selected modulation method as an adaptive modulation request AC222. Subsequently, the radio link control unit A206 of the node A outputs the adaptive modulation request AC222 to a radio circuit multiplexer unit A224 in order to request the transmission device of the node B which transmits the radio signal AD210 to change the modulation method. The radio circuit multiplexer unit A224 multiplexes the adaptive modulation request AC222 in the overhead portion of a radio signal AD227, and outputs the multiplexed data to the wireless transmission device of the node B.

A radio circuit extraction unit B223 of the opposing node B separates the overhead portion of the radio signal AD227, and outputs the separated overhead portion to the radio link control unit 206. The radio link control unit 206 extracts the adaptive modulation request AC222 from the overhead portion, and outputs the extracted adaptive modulation request AC222 to a ring map storage unit B205.

The operation to be performed until an adaptive modulation request is output to the ring map storage unit B205 is as described above. The wireless transmission device in the present exemplary embodiment also performs the following operation regarding the adaptive modulation request AC222.

First of all, a radio link control unit B206 outputs the extracted adaptive modulation request AC222 to a radio circuit multiplexer unit B214 as modulation method information BC213. The radio circuit multiplexer unit B214 multiplexes the modulation method information BC213 in the overhead portion of a radio frame, and the multiplexed radio frame is output to the respective wireless transmission path P1 via the radio circuit multiplexer unit B214, a radio transmission unit B215, and a transmission antenna B216.

As described above regarding the receiving operation, the radio link control unit A206 of the node A stores the modulation method information BC213 extracted from the overhead data C211, and notifies the radio receiving unit A212 of the modulation method information BC213 stored at a time earlier by a predetermined time. The radio receiving unit A212 performs demodulation, based on the modulation method information BC213 from the radio link control unit A206.

(6) Traffic Bypass Operation to be Performed when Fault has Occurred

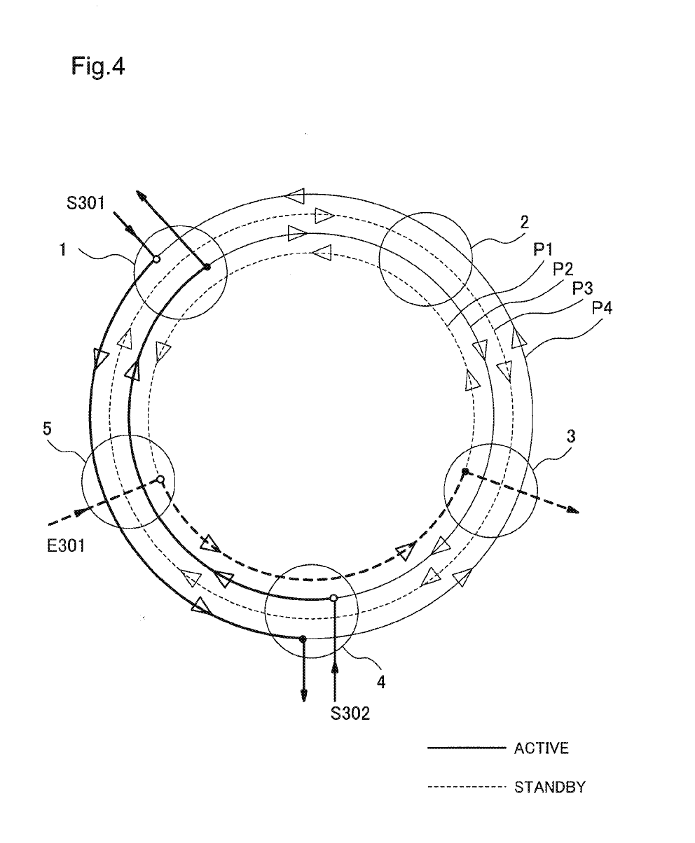

The wireless transmission device in the present exemplary embodiment performs a process of bypassing service traffic or extra traffic so as to continue transmission of the service traffic or extra traffic, when a line fault has occurred in a transmission path. Details of the operation to be performed by the switching circuit unit 203, the switching control unit 204, and the ring map storage unit 205 that implement the process are described in the following referring to FIG. 4 to FIG. 10.

FIG. 4 is a diagram illustrating an example of a communication path set in the wireless transmission system in the first exemplary embodiment of the present invention. FIG. 4 illustrates a manner, in which a communication path is set among the wireless transmission devices 1-5-4, and service traffic S301 input from the wireless transmission device 1 is transferred to the wireless transmission device 4 via the active system transmission path P4 in the counterclockwise direction. Further, FIG. 4 illustrates a manner, in which a communication path is also set among the wireless transmission devices 4-5-1, and service traffic S302 input from the wireless transmission device 4 is transferred to the wireless transmission device 1 via the active system transmission path P2 in the clockwise direction. Furthermore, FIG. 4 illustrates a manner, in which a communication path is set among the wireless transmission devices 5-4-3, and extra traffic E301 is transferred from the wireless transmission device 5 to the wireless transmission device 3 via the standby system transmission path P1 in the counterclockwise direction.

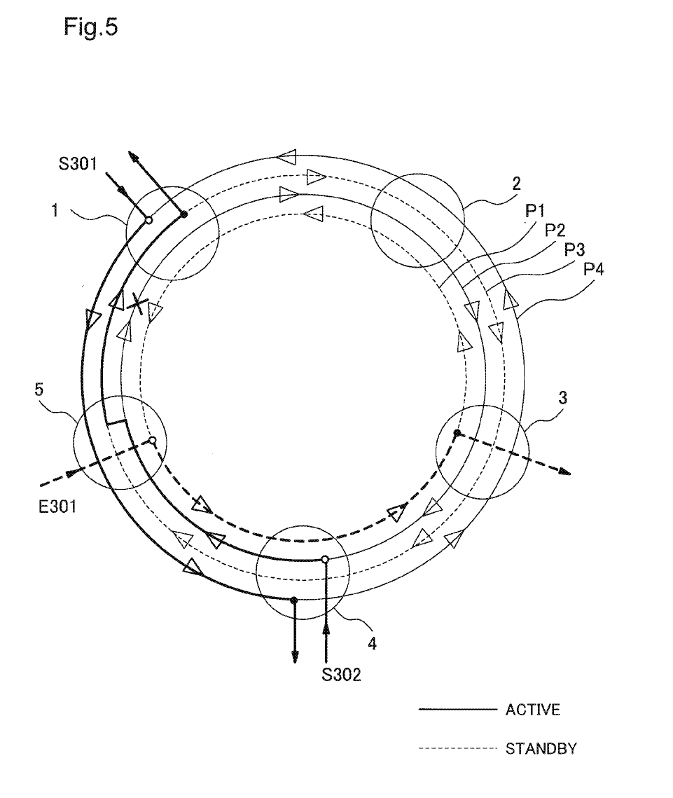

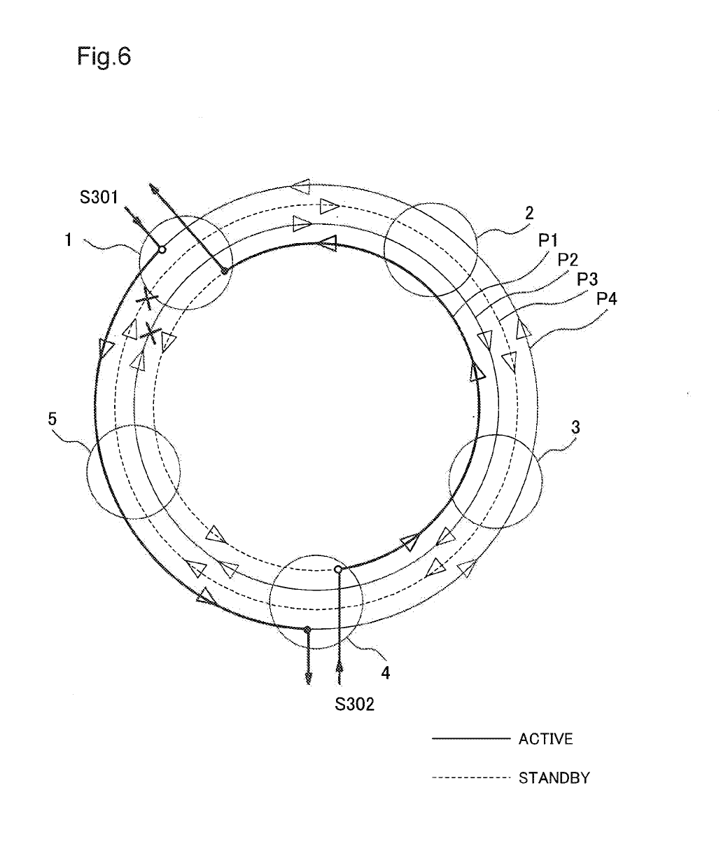

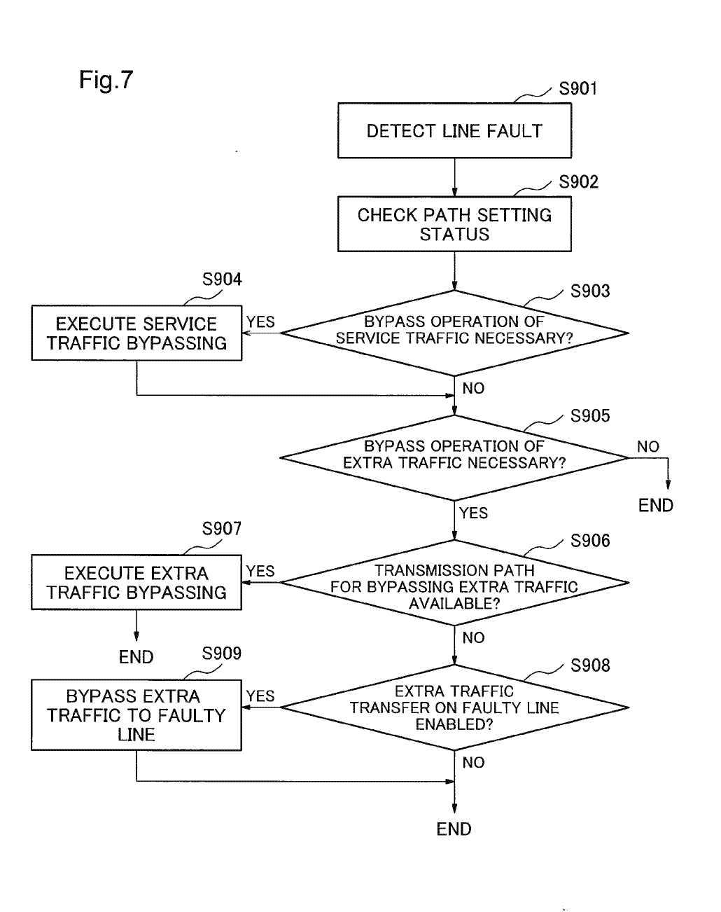

FIG. 5 is a diagram illustrating a setting example of a communication path when a fault has occurred in an active system transmission path of the wireless transmission system in the present exemplary embodiment. FIG. 5 illustrates a setting example of a communication path when a fault has occurred in the active system transmission path P2 between the wireless transmission devices 1-5 from the state in FIG. 4. Further, FIG. 6 is a diagram illustrating a setting example of a communication path when a fault has occurred in the active system and standby system transmission paths of the wireless transmission system in the present exemplary embodiment. FIG. 6 illustrates a setting example of a communication path when a fault has occurred in the active system and standby system transmission paths P2 and P3 between the wireless transmission devices 1-5 from the state in FIG. 4. FIG. 7 is a flowchart illustrating a traffic bypass operation to be performed by a wireless transmission device in the first exemplary embodiment of the present invention.

(6-1) Operation of Ring Map Storage Unit 205

The operation to be performed by the ring map storage unit 205 is summarized as follows. As described above in the section “(4) Supervisory control device”, the ring map storage unit 205 receives and stores a ring map (setting status of the presently set communication path) from the supervisory control device. Further, as described above in the section “(5-3) Calculating operation of modulation method”, the ring map storage unit 205 receives a modulation method (adaptive modulation request) from the radio link control unit 206, and stores the modulation method for each of the wireless transmission paths. Furthermore, as described above in the section “(5-1) Receiving operation”, the ring map storage unit 205 receives the SNR value of each of the wireless transmission paths from the radio link control unit 206, and stores the SNR value for each of the wireless transmission paths.

(6-2) Operation of Switching Circuit Unit 203/Switching Control Unit 204

In this section, an operation to be performed by the switching circuit unit 203/switching control unit 204 is described referring to FIG. 7.

First of all, the respective switching control units 204 of the wireless transmission devices 1-5 monitor the connected wireless transmission paths, and detect a wireless transmission path in which a line fault has occurred (Step S901).

Specifically, the switching control unit 204 measures a received traffic amount for each of the wireless transmission paths. Subsequently, when a transmission traffic amount of each of the wireless transmission paths is input, the switching control unit 204 checks whether the ratio of the received traffic amount with respect to the transmission traffic amount is not larger than a predetermined value for each of the wireless transmission paths for a predetermined period. As a result of the checking, when there is a wireless transmission path whose ratio of the received traffic amount with respect to the transmission traffic amount is not larger than the predetermined value, the switching control unit 204 detects that the wireless transmission path is a wireless transmission path in which a line fault has occurred. The switching control unit 204 may use a modulation method (adaptive modulation request) to be calculated by the radio link control unit A206, in place of using the received traffic amount of each of the wireless transmission paths. In the above modification, the switching control unit 204 checks whether there is a wireless transmission path whose ratio of the traffic amount transmittable by a modulation method (adaptive modulation request) with respect to the transmission traffic amount is not larger than a predetermined value. As a result of the checking, when there is such a wireless transmission path as described above, the switching control unit 204 detects the wireless transmission path as a wireless transmission path in which a line fault has occurred. The switching control unit 204 judges a wireless transmission path whose transmission traffic amount is zero, as a wireless transmission path having no line fault.

Subsequently, when the switching control unit 204 detects a line fault, the switching control unit 204 acquires, from the ring map storage unit 205, the SNR value of the wireless transmission path in which a line fault has occurred. The switching control unit 204 notifies the supervisory control device of information representing the wireless transmission path in which a line fault has occurred (hereinafter, called as a “faulty line”), and a fault status of the faulty line. The fault status includes the SNR value of the faulty line acquired from the ring map storage unit 205.

Subsequently, the supervisory control device notified of the information representing the faulty line and the fault status obtains a faulty section by connecting the faulty lines, and notifies the respective switching control units 204 of the wireless transmission devices 1 to 5 of the faulty section and the fault status, as a fault information notification. Each of the switching control units 204 receives the fault information notification to thereby recognize what fault has occurred in which section of the wireless transmission paths.

Subsequently, each of the switching control units 204 that has received the fault information notification reads out a ring map from the ring map storage unit 205, and recognizes a communication path setting status (Step S902).

### Switching Control of Service Traffic

Subsequently, each of the switching control units 204 judges whether it is necessary to bypass the service traffic (Step S903).

Specifically, each of the switching control units 204 checks, from the fault information notification and the ring map, whether there is a faulty section on a wireless transmission path in which a communication path for use in transmitting service traffic (hereinafter, called as a “service communication path”) is set, out of the communication paths. When there is a faulty section on the wireless transmission path in which the service communication path is set, the switching control unit 204 judges it is necessary to bypass the service traffic. Further, although not illustrated, each of the switching control units 204 checks, from the fault information notification and the ring map, whether a line fault has occurred in all the wireless transmission paths in the same direction as the faulty section.

When each of the switching control units 204 judges that it is necessary to bypass the service traffic, each of the switching control units 204 bypasses the service traffic to a wireless transmission path that does not pass the faulty section, as described in the following sections (I) and (II) (Step S904).

(I) First of all, each of the switching control units 204 recognizes to which one of the wireless transmission devices 1 to 5, it belongs, from a predetermined set value. The predetermined set value is a value representing the wireless transmission devices 1 to 5, and is set in advance in the switching control unit 204 by the user of the wireless transmission system in the present exemplary embodiment. The predetermined set value may be set in the supervisory control device by the user of the wireless transmission system in the present exemplary embodiment, and may be notified to the switching control unit 204 by the supervisory control device. Subsequently, the switching control unit 204 checks, from the ring map and the fault information notification, whether it directly connects with a wireless transmission path in which a fault has occurred and transmits service traffic to the wireless transmission path (hereinafter, called as a “transmission side condition”). When the transmission status of service traffic coincides with the transmission side condition, the switching control unit 204 checks whether a fault has occurred in a wireless transmission path in the same direction as the wireless transmission path in which the fault has occurred, from the fault information notification and the ring map. When a fault has not occurred, the switching control unit 204 selects the wireless transmission path in which a fault has not occurred. Subsequently, the switching control unit 204 notifies the switching circuit unit 203 of the switching control information representing that the selected wireless transmission path serves as an output destination transmission path. The switching circuit unit 203 switches the output destination transmission path to a wireless transmission path represented by the switching control information. As a result of the switching operation, even when a fault has occurred in a wireless transmission path to be connected, the wireless transmission device is allowed to switch the service traffic to the wireless transmission path in the same direction (hereinafter, called as “span switching”) for avoiding a faulty section. For instance, in the case of FIG. 5, the wireless transmission device 5 performs span switching to the standby system transmission path P3 in the same direction as the active system transmission path P2 in which a fault has occurred for avoiding a faulty section.

(II) In Step S903 as described above, when it is checked that a fault has occurred in all the wireless transmission paths in the same direction as the faulty section, the switching control unit 204 of the wireless transmission device which receives the service traffic from the wired line side checks whether it is possible to bypass the service traffic to a wireless transmission path in the opposite direction to the direction of the service communication path. Hereinafter, the switching control unit 204 of the wireless transmission device which receives the service traffic from the wired line side is called as a “transmission source switching control unit 204”. Specifically, the transmission source switching control unit 204 checks, from the fault information notification and the ring map, whether it is possible to bypass the service traffic to a wireless transmission path in the opposite direction to the direction of the wireless transmission path in which a service communication path is set. When it is possible to bypass the service traffic, the transmission source switching control unit 204 selects the wireless transmission path. The switching control unit 204 notifies the switching circuit unit 203 of the switching control information representing that the selected wireless transmission path serves as an output destination transmission path. The switching circuit unit 203 switches the output destination transmission path to the selected wireless transmission path. As a result of the switching operation, the wireless transmission device in the present exemplary embodiment switches the service traffic to the wireless transmission path in the opposite direction (hereinafter, called as a “ring switching”) for avoiding a faulty section. For instance, in the case of FIG. 6, the wireless communication transmission device 4 as a transmission source outputs the service traffic S302 to the standby system transmission path P1 in the opposite direction to the direction of the active system and standby system transmission paths P2 and P3 in which a fault has occurred for avoiding a faulty section.

When the span switching is performed, the extra traffic that has been transmitted by the transmission path to evacuate service traffic is cut off. When a communication path of extra traffic is cut off, the switching control unit 204 sets a communication path again in a section which does not affect the service traffic by a well-known function, and continues communication.

### Switching Control of Extra Traffic

Subsequently, the switching control unit 204 judges whether it is necessary to bypass the extra traffic (Step S905).

Specifically, the switching control unit 204 checks, from the fault information notification and the ring map, whether there is a faulty section on a wireless transmission path in which a communication path for use in transmitting extra traffic (hereinafter, called as “extra communication path”) is set, out of the communication paths. The switching control unit 204 judges that it is necessary to bypass the extra traffic, when there is a faulty section on the wireless transmission path in which the extra communication path is set.

When the switching control unit 204 judges that it is necessary to bypass the extra traffic, the switching control unit 204 checks, from the fault information notification and the ring map, whether an unused transmission path for use in transmitting the extra traffic is available (Step S906).

When an unused transmission path for use in transmitting the extra traffic is available, the switching control unit 204 bypasses the extra traffic to the transmission path, with use of the switching circuit unit 203 (Step S907).

The concrete methods of Steps S906 and S907 are the same as the methods (I) and (II) as described above. However, the “service communication path” is read as the “extra communication path”, and the “service traffic” is read as the “extra traffic”. Further, the “wireless transmission path in the same direction” is read as the “unused wireless transmission path in the same direction”, and the “wireless transmission path in the opposite direction” is read as the “unused wireless transmission path in the opposite direction”.

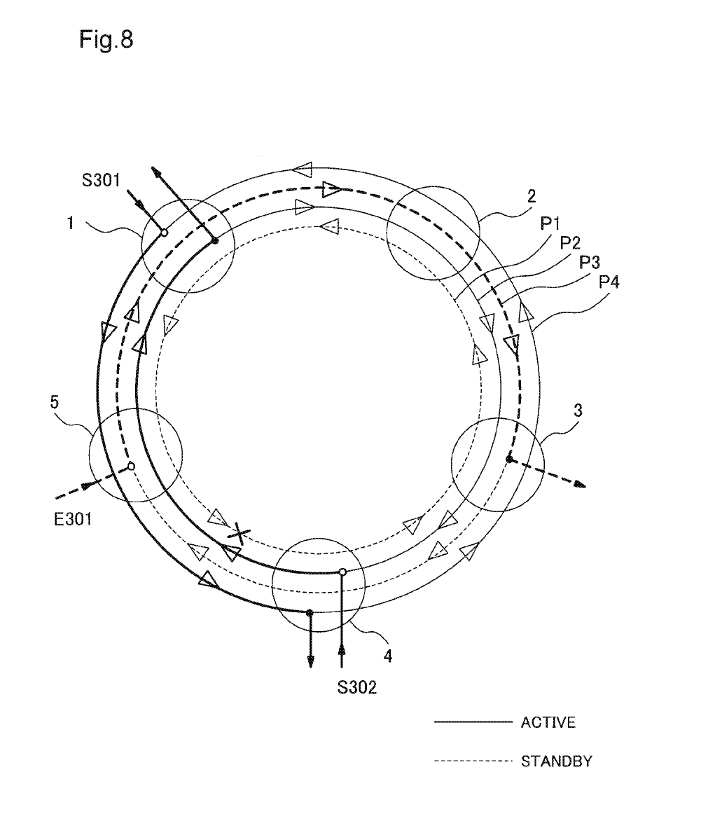

FIG. 8 is a diagram illustrating a setting example of a communication path, when a fault has occurred in the standby system transmission path of the wireless transmission system in the present exemplary embodiment. FIG. 8 illustrates a setting example of a communication path, when a fault has occurred in the counterclockwise standby system transmission path P1 (among the wireless transmission devices 5-4-3) along which the extra traffic E301 is transmitted, from the communication path setting state in FIG. 4. As the clockwise standby system transmission path P3 is an unused wireless transmission path, the switching control unit 204 of the wireless transmission device 5 performs ring switching, and bypasses the extra traffic to the clockwise standby system transmission path P3 for avoiding a faulty section.

### Switching Control When Path for Bypassing Extra Traffic is Not Available

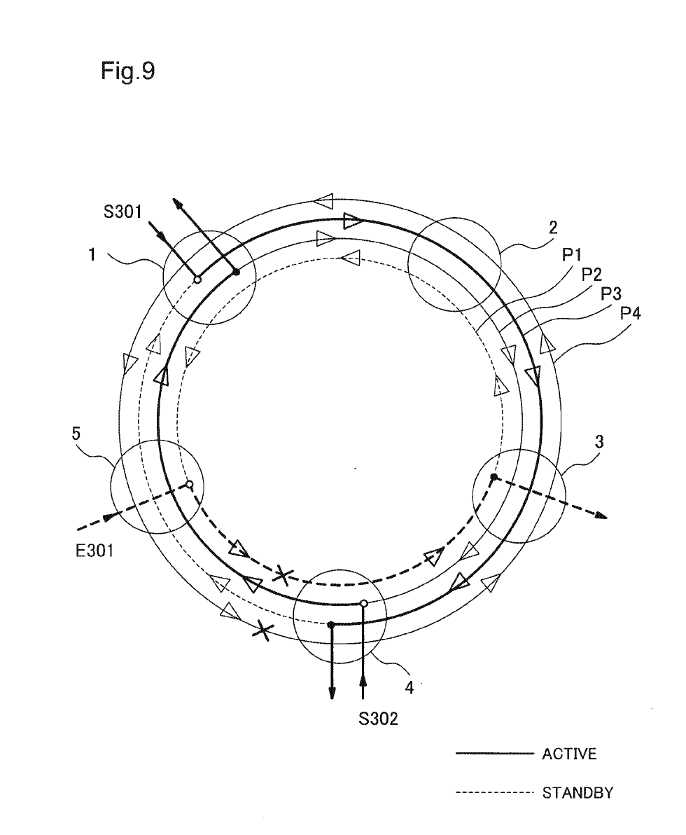

FIG. 9 is a diagram illustrating a setting example of a communication path, when a path for bypassing extra traffic by the wireless transmission system in the first exemplary embodiment of the present invention is not available. FIG. 9 illustrates a case, in which a line fault has occurred in the standby system transmission path P1 and the active system transmission path P4 between the wireless transmission devices 4-5, from the communication path setting state in FIG. 4, and an unused transmission path for bypassing the extra traffic E301 is not available.

When an unused transmission path for bypassing is not available as illustrated in FIG. 9, the switching control unit 204 of the wireless transmission device for transmitting the extra traffic to a wireless transmission path in which a fault has occurred judges whether it is possible to transmit the extra traffic along the transmission path in which a line fault has occurred even at a lower speed (Step S908).

Specifically, the switching control unit 204 acquires a modulation method (adaptive modulation request) of the transmission path in which a fault has occurred from the ring map storage unit 205, and acquires the SNR value of the transmission path in which the fault has occurred from the fault information notification. Subsequently, the switching control unit 204 checks that the acquired modulation method is a modulation method whose multi-value number is not larger than a predetermined number and that the acquired SNR value is not lower than a predetermined value (hereinafter, called as a “low-speed line use condition”). The switching control unit 204 judges that the transmission path in which a line fault has occurred is usable as a low-speed line when the low-speed line use condition is satisfied, and selects the transmission path as the low-speed line.

In the case of FIG. 9, the switching control unit 204 of the wireless transmission device 5 acquires the modulation method and the SNR value of the transmission paths P1 and P4 in which a line fault has occurred from the ring map storage unit 205 and the fault information notification. The switching control unit 204 of the wireless transmission device 5 checks, regarding each of the transmission paths P1 and P4, that the acquired modulation method is a modulation method whose multi-value number is not larger than a predetermined number, and that the SNR value is not lower than a predetermined value, in other words, the low-speed line use condition is satisfied. The switching control unit 204 judges that the transmission path that satisfies the low-speed line use condition is a wireless transmission path capable of transmission even at a lower speed. The wireless transmission path capable of transmission even at a lower speed is hereinafter called as a “transmission path usable as a low-speed line”. When there are two or more transmission paths usable as a low-speed line, the switching control unit 204 selects a line whose line speed is faster, in other words, a transmission path of a modulation method whose multi-value number is the largest, as a wireless transmission path usable as a low-speed line.

Subsequently, the switching control unit 204 performs an operation of switching a transmission path to which the extra traffic is output, to a transmission path usable at a low speed (hereinafter, called as a “low-speed transmission path”) (Step S909).

Specifically, the switching control unit 204 notifies the switching circuit unit 203 of the switching control information representing that the output destination transmission path is a low-speed transmission path. The switching circuit unit 203 switches the output destination transmission path to the low-speed transmission path. In the case of FIG. 9, the switching control unit 204 of the wireless transmission device 5 bypasses the extra traffic E301 to one of the transmission paths P1 and P4, when the transmission paths P1 and P4 in which a line fault has occurred satisfy the low-speed line use condition.

### Description of Advantageous Effects

According to the present exemplary embodiment, the transmission system is capable of continuing transmission of extra traffic, without affecting transmission of service traffic, even when an unused and bypassable transmission path is not available at the time of line fault (hereinafter, this case is called as a “case where there is no bypass”).

The reason for the above is as follows. The transmission system in the present exemplary embodiment is constituted of transmission paths with use of radio lines. Even when there is no bypass at the time of line fault, the transmission system judges whether the extra traffic is transmittable along a transmission path in which a fault has occurred. When the transmission system judges that the extra traffic is transmittable, the transmission system bypasses the extra traffic to the transmission path.

Further, the transmission system in the present exemplary embodiment uses a faulty transmission path along which service traffic is not transmitted. This makes it possible to continue transmission of extra traffic without affecting the service traffic.

### Second Exemplary Embodiment

In the following, the second exemplary embodiment of the present invention is described.

### Description of Configuration

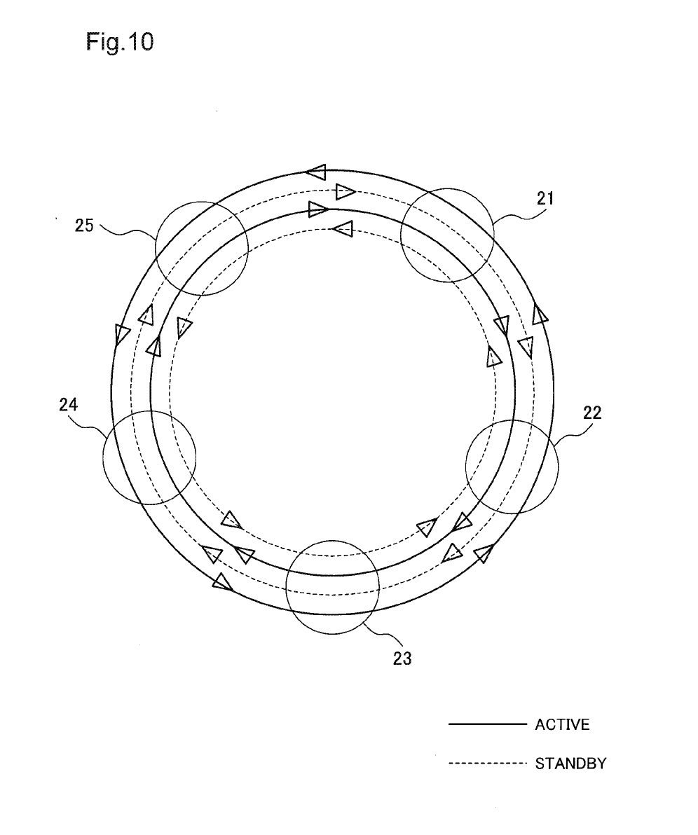

FIG. 10 is a diagram illustrating a configuration example of a wireless transmission system in the second exemplary embodiment of the present invention. The wireless transmission system in the second exemplary embodiment of the present invention is a wireless transmission system in which a plurality of wireless transmission devices are connected via a plurality of wireless transmission paths. Whereas FIG. 10 illustrates five wireless transmission devices 21 to 25, the number of wireless transmission devices is not limited to the above.

Each of the wireless transmission devices 21 to 25 is a wireless transmission device for transmitting traffic to the other one of the wireless transmission devices via a wireless transmission path selected from among the connected wireless transmission paths. Each of the wireless transmission devices 21 to 25 is provided with a switching control unit which selects a wireless transmission path for transmitting traffic from among the wireless transmission paths.

The switching control unit judges whether it is possible to transmit the traffic with use of a wireless transmission path in which a fault has occurred, namely, with use of a faulty transmission path, when the fault has occurred in the wireless transmission path for transmitting the traffic. Further, the switching control unit selects the faulty transmission path, as a wireless transmission path for transmitting the traffic, when it is possible to transmit the traffic with use of the faulty transmission path.

### Description of Operation

The switching control unit judges whether it is possible to transmit the traffic with use of a wireless transmission path in which a fault has occurred, namely, with use of a faulty transmission path, when the fault has occurred in the wireless transmission path for transmitting the traffic. The traffic may be extra traffic.

In order to judge whether it is possible to transmit the traffic with use of a faulty transmission path, first of all, the switching control unit receives, from the other one of the wireless transmission devices directly connected via the faulty transmission path, the modulation method and the SNR value relating to the faulty transmission path. Subsequently, the switching control unit judges that extra traffic is transmittable along the faulty transmission path, when the received modulation method is a modulation method whose multi-value number is not larger than a predetermined number, and when the SNR value is not lower than a predetermined value.

Subsequently, the switching control unit selects the faulty transmission path as a wireless transmission path for transmitting the traffic, when it is possible to transmit the traffic with use of the faulty transmission path.

The wireless transmission system in the second exemplary embodiment of the present invention is not limited to a configuration, in which the wireless transmission devices 21 to 25 are connected in the form of a ring. The wireless transmission system in the second exemplary embodiment of the present invention may be such that a plurality of unillustrated wireless transmission devices are connected in the form of a star or in the form of a mesh.

### Description of Advantageous Effects

According to the present exemplary embodiment, the transmission system is capable of continuing transmission of extra traffic, without affecting transmission of service traffic, even when an unused and bypassable transmission path is not available at the time of line fault (hereinafter, this case is called as a “case where there is no bypass”).

The reason for the above is as follows. The transmission system in the present exemplary embodiment is constituted of transmission paths with use of radio lines. Even when there is no bypass at the time of line fault, the transmission system judges whether it is possible to transmit the traffic along a transmission path in which a fault has occurred. When it is possible to transmit the traffic, the transmission system bypasses the extra traffic to the transmission path.

The above-described exemplary embodiments are not limited to the embodiments, and may be modified in various ways when the invention is carried out, as far as such modifications do not depart from the gist of the invention.

This application is based upon and claims the benefit of priority from Japanese Patent Application No. 2012-148403 filed on Jul. 2, 2012, the disclosure of which is incorporated herein in its entirety by reference.

The whole or part of the exemplary embodiments disclosed above can be described as, but not limited to, the following supplementary notes.

### Supplementary Note 1

A wireless transmission device for transmitting traffic to another wireless transmission device via a selected one of a plurality of connected wireless transmission paths, the wireless transmission device comprising:

a switching control unit which judges, when a fault has occurred in the wireless transmission path for transmitting the traffic, whether the traffic is transmittable with use of the wireless transmission path in which the fault has occurred, namely, a faulty transmission path, and which selects the faulty transmission path, as the wireless transmission path for transmitting the traffic, when judging that the traffic is transmittable.

### Supplementary Note 2

The wireless transmission device according to Supplementary Note 1, wherein

when there are a plurality of faulty transmission paths capable of transmitting the traffic, the switching control unit selects the faulty transmission path whose transmission capacity is the largest, as the wireless transmission path for transmitting the traffic.

### Supplementary Note 3

The wireless transmission device according to any one of Supplementary Notes 1 to 2, wherein

the switching control unit receives a modulation method and an SNR (Signal to noise ratio) value relating to the faulty transmission path from the another wireless transmission device directly connected via the faulty transmission path, and judges that the traffic is transmittable by the faulty transmission path, when the modulation method is the modulation method whose multi-value number is not larger than a predetermined number, and when the SNR value is not lower than a predetermined value.

### Supplementary Note 4

The wireless transmission device according to any one of Supplementary Notes 1 to 3, wherein

the switching control unit judges whether the traffic is transmittable with use of the faulty transmission path, when transmission of the traffic by the wireless transmission path other than the faulty transmission path is disabled.

### Supplementary Note 5

The wireless transmission device according to any one of Supplementary Notes 1 to 4, wherein

the traffic is low priority information, namely, extra traffic.

### Supplementary Note 6

A wireless transmission system comprising two or more wireless transmission devices connected via a plurality of wireless transmission paths, wherein

each of the wireless transmission device is the wireless transmission device according to any one of Supplementary Notes 1 to 5.

### Supplementary Note 7

The wireless transmission system according to Supplementary Note 6, wherein

the two or more wireless transmission devices are connected in the form of a ring.

### Supplementary Note 8

A communication line selection method for selecting a wireless transmission path from a plurality of wireless transmission paths so as to transmit traffic to a communication destination, comprising:

judging, when a fault has occurred in the wireless transmission path for transmitting the traffic, whether the traffic is transmittable with use of the wireless transmission path in which the fault has occurred, namely, a faulty transmission path, and selecting the faulty transmission path as the wireless transmission path for transmitting the traffic, when judging that the traffic is transmittable.

### Supplementary Note 9

The communication line selection method according to Supplementary Note 8, wherein

when there are a plurality of faulty transmission paths capable of transmitting the traffic, selecting the faulty transmission path whose transmission capacity is the largest as the wireless transmission path for transmitting the traffic.

### Supplementary Note 10

The communication line selection method according to Supplementary Notes 8 to 9, wherein

receiving a modulation method and an SNR value relating to the faulty transmission path, and judging that the traffic is transmittable by the faulty transmission path, when the modulation method is the modulation method whose multi-value number is not larger than a predetermined number, and when the SNR value is not lower than a predetermined value.

### Supplementary Note 11

The wireless transmission device according to any one of Supplementary Notes 3 to 5, wherein

the faulty transmission path whose transmission capacity is the largest is the faulty transmission path of the modulation method whose multi-value number is the largest.

### Supplementary Note 12

The wireless transmission device according to any one of Supplementary Notes 1 to 5, or 11, wherein

the switching control unit measures a traffic amount of traffic to be received from the wireless transmission path for each of the wireless transmission paths, and

in response to input of a traffic amount of traffic to be received by a wireless transmission system constituted of the wireless transmission devices, namely a transmission traffic amount, the switching control unit judges that the fault has occurred in the wireless transmission path for transmitting the traffic, when there is the wireless transmission path whose ratio of the received traffic amount with respect to the transmission traffic amount is not larger than a predetermined value for a predetermined period.

### Supplementary Note 13

The wireless transmission system according to any one of Supplementary Notes 6 to 7, wherein

the wireless transmission path is a duplex wireless transmission path constituted of an active system wireless transmission path and a standby system wireless transmission path.

### Supplementary Note 14

The communication line selection method according to Supplementary Note 10, wherein

the faulty transmission path whose transmission capacity is the largest is the faulty transmission path of the modulation method whose multi-value number is the largest.

### Supplementary Note 15

The communication line selection method according to any one of Supplementary Notes 8 to 10, or 14, wherein

judging whether the traffic is transmittable with use of the faulty transmission path, when transmission of the traffic by the wireless transmission path other than the faulty transmission path is disabled.

### Supplementary Note 16

The communication line selection method according to any one of Supplementary Notes 8 to 10, or 14 to 15, wherein

the traffic is low priority information, namely, extra traffic.

### REFERENCE SIGNS LIST

1, 2, 3, 4, 5 Wireless transmission device
21, 22, 23, 24, 25 Wireless transmission device
201, 202 IF circuit unit
203 Switching circuit unit
204 Switching control unit
205 Ring map storage unit
206 Radio link control unit
211, 221, 231, 241 Receiving antenna
212, 222, 232, 242 Radio receiving unit
213, 223, 233, 243 Radio circuit extraction unit
214, 224, 234, 244 Radio circuit multiplexer unit
215, 225, 235, 245 Radio transmission unit
216, 226, 236, 246 Transmission antenna

1. A wireless transmission device for transmitting traffic to another wireless transmission device via a selected one of a plurality of connected wireless transmission paths, the wireless transmission device comprising:
a switching control unit which judges, when a fault has occurred in the wireless transmission path for transmitting the traffic, whether the traffic is transmittable with use of the wireless transmission path in which the fault has occurred, namely, a faulty transmission path, and which selects the faulty transmission path, as the wireless transmission path for transmitting the traffic, when judging that the traffic is transmittable.

2. The wireless transmission device according to claim 1, wherein
when there are a plurality of faulty transmission paths capable of transmitting the traffic, the switching control unit selects the faulty transmission path whose transmission capacity is the largest, as the wireless transmission path for transmitting the traffic.

3. The wireless transmission device according to claim 1, wherein
the switching control unit receives a modulation method and an SNR (Signal to noise ratio) value relating to the faulty transmission path from the another wireless transmission device directly connected via the faulty transmission path, and judges that the traffic is transmittable by the faulty transmission path, when the modulation method is the modulation method whose multi-value number is not larger than a predetermined number, and when the SNR value is not lower than a predetermined value.

4. The wireless transmission device according to claim 1, wherein
the switching control unit judges whether the traffic is transmittable with use of the faulty transmission path, when transmission of the traffic by the wireless transmission path other than the faulty transmission path is disabled.

5. The wireless transmission device according to claim 1, wherein
the traffic is low priority information, namely, extra traffic.

6. A wireless transmission system comprising two or more wireless transmission devices connected via a plurality of wireless transmission paths, wherein
each of the wireless transmission devices is the wireless transmission device according to claim 1.

7. The wireless transmission system according to claim 6, wherein
the two or more wireless transmission devices are connected in the form of a ring.

8. A communication line selection method for selecting a wireless transmission path from a plurality of wireless transmission paths so as to transmit traffic to a communication destination, comprising:
judging, when a fault has occurred in the wireless transmission path for transmitting the traffic, whether the traffic is transmittable with use of the wireless transmission path in which the fault has occurred, namely, a faulty transmission path, and selecting the faulty transmission path as the wireless transmission path for transmitting the traffic, when judging that the traffic is transmittable.

9. The communication line selection method according to claim 8, wherein
when there are a plurality of faulty transmission paths capable of transmitting the traffic, selecting the faulty transmission path whose transmission capacity is the largest as the wireless transmission path for transmitting the traffic.

10. The communication line selection method according to claim 8, wherein
receiving a modulation method and an SNR value relating to the faulty transmission path, and judging that the traffic is transmittable by the faulty transmission path, when the modulation method is the modulation method whose multi-value number is not larger than a predetermined number, and when the SNR value is not lower than a predetermined value.

11. The wireless transmission device according to claim 3, wherein
the faulty transmission path whose transmission capacity is the largest is the faulty transmission path of the modulation method whose multi-value number is the largest.

12. The wireless transmission device according to claim 1, wherein
the switching control unit measures a traffic amount of traffic to be received from the wireless transmission path for each of the wireless transmission paths, and
in response to input of a traffic amount of traffic to be received by a wireless transmission system constituted of the wireless transmission devices, namely a transmission traffic amount, the switching control unit judges that the fault has occurred in the wireless transmission path for transmitting the traffic, when there is the wireless transmission path whose ratio of the received traffic amount with respect to the transmission traffic amount is not larger than a predetermined value for a predetermined period.

13. The wireless transmission system according to claim 6, wherein
the wireless transmission path is a duplex wireless transmission path constituted of an active system wireless transmission path and a standby system wireless transmission path.

14. The communication line selection method according to claim 10, wherein
the faulty transmission path whose transmission capacity is the largest is the faulty transmission path of the modulation method whose multi-value number is the largest.

15. The communication line selection method according to claim 8, wherein
judging whether the traffic is transmittable with use of the faulty transmission path, when transmission of the traffic by the wireless transmission path other than the faulty transmission path is disabled.

16. The communication line selection method according to claim 8, wherein
the traffic is low priority information, namely, extra traffic.
